(19) United States
(12) Patent Application Publication
(10) Pub. No.: US 2002/0162616 A1
(43) Pub. Date: Nov. 7, 2002

(54) Passenger tire with chapex construction

(76) Inventors: Philippe Pascal Gilles Bernard, Bastogne (BE); Erick Sigfried Espinosa, Copley, OH (US); Klaus-Dieter Schultz, Fouhren (LU)

Correspondence Address: The Goodyear Tire & Rubber Company, Patent & Trademark Department - D/823, 1144 East Market Street, Akron, OH, 44316-0001, US

(21) Appl. No.: 09/846,993

(22) Filed: May 1, 2001

(51) Int. Cl. B60C 15/00

(52) U.S. Cl. 152/551; 152/450; 152/544; 152/393

(57) ABSTRACT

A monoply pneumatic tire has a reinforced sidewall wherein the reinforcement comprises an extra long turn-up which extends into the belt area of the tire. The tire also has a robust chapex in the bead area of the sidewall which has a shape that results from wrapping the turn-up of the carcass ply around the bead of the tire without an apex. The chapex conforms to the shape of the bead. The material in the chapex corresponds in volume substantially to the combined volume of the apex and the chafer of a similarly sized tire.

### FIELD OF THE INVENTION

The present invention relates to the bead portion of a pneumatic tire, more specifically to a monoply tire having a bead portion with no apex and a locked-in bead structure when mounted on a specified rim.

### BACKGROUND OF THE INVENTION

As new materials are developed, and the strength of the materials increases, more simplified constructions of pneumatic tires are possible. For example, where in the past radial ply tires were made almost exclusively using two carcass plies, in recent years, monoply carcass constructions are being developed. There are some instances, however, for example where a tire is expected to be used under rigorous conditions, such as on unpaved roads, or roads that have a tendency to have potholes, that the extra reinforcement provided by two carcass plies is still needed in the sidewall area of the tire. In the prior art, this additional reinforcement, in some cases, is provided by an extra long turn-up ply, which extends to the belt edge of a tire. Thus, even though a monoply construction is used, in a sidewall area of the tire where the turn-up overlaps with the main body of the carcass ply, two layers of carcass reinforcement are provided.

In prior art two ply constructions, it has been found that the lower sidewall area of a tire, especially in the bead area, can be made stronger using a locked tie-in bead construction, such as described in U.S. Pat. Nos. 4,922,985; 5,058,649 and especially U.S. Pat. No. 5,524,688, issued Jun. 11, 1996, said latter patent being incorporated herein by reference. In the construction described, no apex is used, and the turn-ups of the two carcass plies are wrapped around each bead, and a chapex (i.e., a combined chafer and apex) locks the turn-ups against the bead and against the main body of the carcass plies.

Goodyear has used a locked tie in construction in the past on monoply tires having a short or high turn-up (i.e. a turn-up less than the section width of the tire). As far as applicant is aware, the instantly claimed construction has never been used on a tire having an “envelope ply”, i.e., a turn-up that extends into the belt area of the tire.

### SUMMARY OF THE INVENTION

The invention relates to a pneumatic tire for a 1500 to 5000 pound (3300 to 11,000 Kg) vehicle, having a standard load capacity for such a vehicle. The tire has an aspect ratio of 60 to 85, a tread width of 105 to 170 mm, and a diameter of 10 to 15 inches (25 to 38 cm). The tire further comprises a pair of annular beads (28), a single carcass ply (18) wrapped around the beads, belt/breaker reinforcement (25) disposed over the carcass ply (18) in a crown area of the tire, and tread (12) disposed over the belt/breaker reinforcement (25). The tire is characterized by a turn up (22) of carcass ply (18) extending the full height of sidewall (14) and having an end (24) disposed radially inward of belt edge (26) in a crown area of the tire, the turn-up (22) being wrapped substantially around bead (28) and being substantially contiguous with carcass ply (18) substantially from bead (28) to end (24). The tire has a chafer (34) which substantially fills the area radially outward of bead (28) and the axially outward surface of turn up (22) substantially from bead (28) to substantially 60% to 90% of the distance from bead (28) to the section width (SW) of the tire.

In an illustrated embodiment, the tire has an aspect ratio of 60 to 80. Also, the chafer (34) overlaps with sidewall (14) over 40% to 75% of the distance from toe (34b) of chafer (34) to tip (34a) of chafer (34).

It is a continuing goal in the art to simplify the construction of pneumatic tires, while at the same time increasing the tire's robustness in specific areas of the tire where it is believed that a robust construction is needed.

Further objects of the invention will be apparent from the following description and claims.

### BRIEF DESCRIPTION OF THE DRAWINGS

FIG. 1 illustrates a prior art tire having a monoply construction with an extended carcass ply turn-up.

FIG. 2 illustrates a monoply tire of the invention having an extended ply turn-up and a locked bead (chapex) construction.

### DETAILED DESCRIPTION OF THE INVENTION

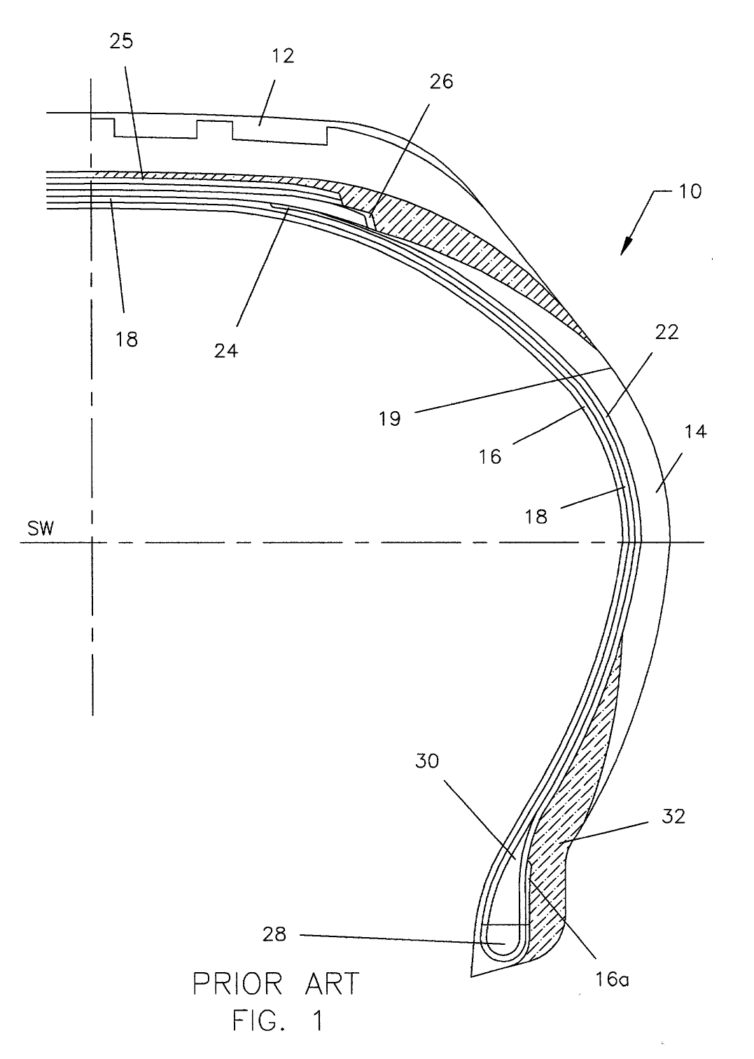

With reference now to FIG. 1, in a prior art tire known as the “envelope ply tie-in” construction, a single carcass ply (18) is wrapped around a pair of spaced apart annular beads (28), and the turn-up (22) of the carcass ply extends up into the belt area of the tire so that the end of the carcass ply (24) fits under the belt edges (26). The beads (28) may comprise a plurality of wraps of a single metallic filament. Other types of beads are known to those skilled in the art. Belt reinforcement (25) provides reinforcement for the tire radially outward of carcass ply (18) in the crown area of the tire radially inward of tread (12). The tire is also made with an apex (30) adjacent bead (28), which is disposed between carcass ply (18) and ply turn-up (22). A chafer (32) is disposed axially outwardly of turn-up (22) in the bead area of the tire, and is overlapped by sidewall (14). In the illustrated tire construction, an inner liner (16) is provided which, for ease of construction, may be extended to wrap around bead (28) and turn-up (16a). In such a construction, the rubber of the inner liner portion (16a) mingles with the rubber of chafer (32) when the tire is cured.

In a tire construction, the main portion of the carcass ply refers to the portion of the carcass ply which extends between the bead cores of the tire. The carcass ply comprises reinforcing cords embedded in an elastomer, providing an elastomer/reinforcement composite. The turn-up portion of the carcass ply is disposed radially and axially outward of the bead cores, and in the prior art tire passes over the apex, and is in contact with the main portion of the carcass ply a suitable distance. The bead portion of the tire, in addition to the bead core and the turn-up ply, comprises elastomeric materials which surround the bead and the turn-up ply.

As used herein, the terms “radial” and “radially” refer to directions going towards or away from the axis of rotation of the tire. The terms “axial” and “axially” indicate directions that are parallel to the axis of rotation of a tire.

In prior art tires, other components that may be located in the bead portion of the tire include a toe guard and a chafer strip. In most cases, the “toe guard” is a layer of reinforcing cords folded around the carcass ply and bead core on the side of the carcass ply furthest away from the bead core. The primary purpose of a toe guard is to protect the bead from damage during mounting of the tire on a rim and to protect the toe of the tire during subsequent use of the tire on the rim. A chafer may be either a tough elastomeric material that protects the bead portion from abrasion during mounting and use of the tire, or a layer of fabric extending from radially inward of the bead core to the same radial height as the edge of the turn-up. The reinforcement cords of the carcass ply (18) are oriented such that the tire is what is commonly referred to in the art as a radial ply tire.

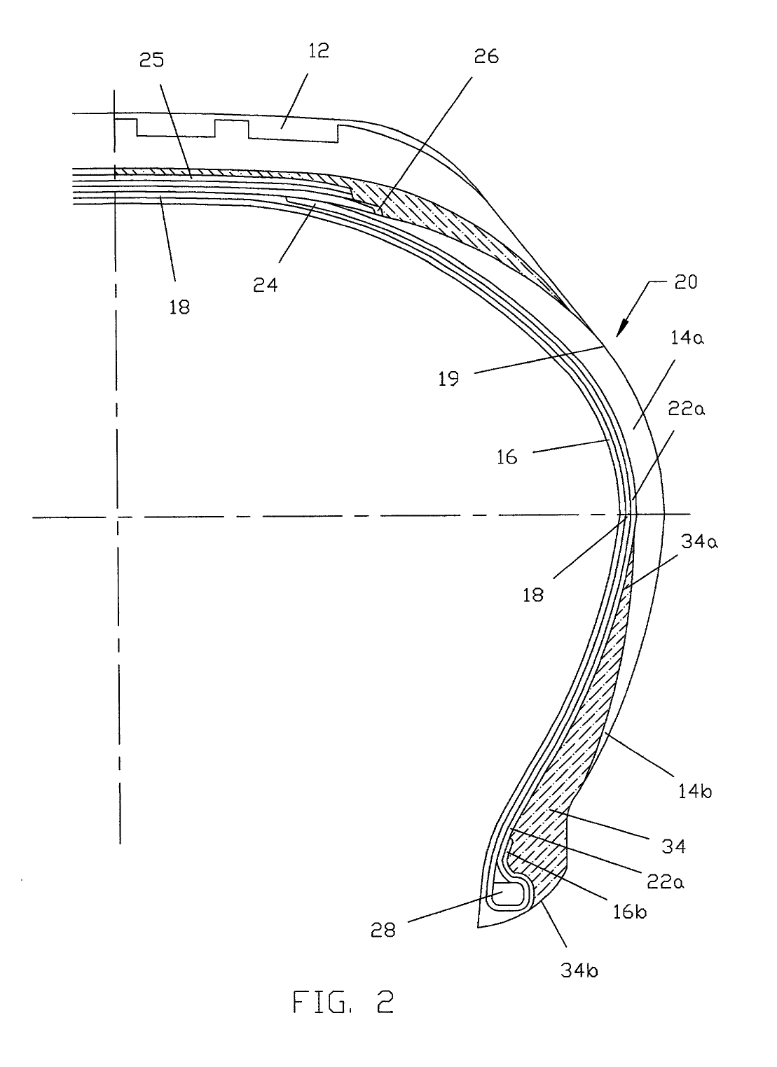

In the tire 20 of the invention, as shown in FIG. 2, a similar monoply construction is used wherein a single carcass ply (18) is wrapped around a bead (28), the difference being that turn-up (22a) substantially circles around bead (28), i.e., there is no apex (30) provided between carcass ply (18) and turn-up (22a) as was present in the prior art tire. Instead, a chapex (34) is provided which is shaped to fit over the top of the bead, locking turn-up ply (22a) against the bead and against carcass ply (18). Chapex (34) is substantially thicker than the prior art chafer (32), and because of its leverage against bead (28), reduces the flexibility of the bead area of the tire. Chapex (34) is wedge shaped and extends 60% to 90% of the distance from the bead (28) to the section width (SW) of the tire, and wedge shaped end (34a) is overlapped by sidewall (14a) such that the sidewall feathers down to a point (14b) which is 50 to 80% of the distance from the section width (SW) of the tire to bead (28). Tire (20) is otherwise constructed similar to the prior art tire shown in FIG. 1.

The chapex (34) is an elastomeric stiffening member comprising an elastomer having a Shore A Hardness of 60 or greater and a Young's modulus of 1700 pounds per square inch (psi) or greater. Chapex (34) extends axially outwardly of the bead and the carcass ply turn-up and extends from a radially inner end (34b) located at the radially outermost extent of the bead core (28) and turn-up (22a), to a radially outer end which is disposed radially outward of a rim flange of a rim on which the tire is designed to be mounted.

In an alternative embodiment, chapex (34) may comprise co-extruded compounds which have different properties. The properties of the compounds can be engineered to provide extra stiffness to the inner portion of the chafer, to stiffen the lower sidewall of the tire, which is believed to provide better handling in the tire.

A less stiff compound in the outer portion of the chapex may cushion the carcass ply (18) and the turn-up (22a) against road hazards, and to minimize rim chafing. Turn-up (22a) substantially circles around bead (28), i.e., there is no apex (30) provided between carcass ply (18) and turn-up (22a) as was present in the prior art tire. Instead, a chafer (34) is provided which is shaped to fit over the top of the bead, locking turn-up ply (22a) against the top of the bead.

There are fewer components, so the tire construction of the invention is easier to build. The robustness of chafer (34), and its shape wherein it surrounds bead (28), reduces the flexibility of the bead area of the tire, so that when the tire hits a pothole, for example, the tire does not pinch down on the bead. It is believed that the tire construction of the invention increases the bead durability of a tire in which it is used.

The tire construction of the invention is particularly adapted for passenger tires, i.e., for vehicles having a weight in the range of 1500 to 5000 pounds (3300 to 11,000 kg). The tire is designed to handle the standard load capacity of such a vehicle. The tire may have an aspect ratio of 60 to 85, preferably 60 to 80, a tread width of 105 to 170 mm, and a diameter of 10 to 15 inches (25 to 38 cm).

In the illustrated embodiment, chapex (34) comprises a compound having a Hardness of Shore A>60. The volume of chapex (34) comprises 75% to 95% of the total volume of the apex (30) and chafer (32) in a similarly sized prior art tire, and accordingly provides a weight savings as well as reducing the number of components in the tire. The added thickness of the chapex (34), from its location above the bead adjacent inner liner (16b), to its axially outer surface, besides locking in the turn-up, provides additional chaffing protection to the bead (28) and turn-up (22a) at the bead than is seen in the prior art tire.

The stiff lower sidewall forces flexion of the sidewall closer to the shoulder (19) of tire (20), further stabilizing the lower sidewall of the tire.

In an illustrated embodiment, tires having a tread width of 105 to 170 mm and aspect ratios of 60 to 80 have been constructed. The illustrated tires have a chapex (34) which overlaps with sidewall (14) about 40% to 75% of the distance from toe (34b) of chapex (34) to tip 34a of chapex (34).

While the invention has been specifically illustrated and described, those skilled in the art will recognize that the invention may be variously modified and practiced without departing from the spirit of the invention. The invention is limited only by the scope of the following claims.

What is claimed is:

1. A pneumatic tire for a 1500 to 5000 pounds (3300 to 11,000 Kg) vehicle and having a standard load capacity for such a vehicle, said tire having an aspect ratio of 60 to 85, a tread width of 105 to 170 mm, and a diameter of 10 to 15 inches (25.4 to 38 cm), said tire comprising a pair of annular beads (28), a single carcass ply (18) wrapped around said beads, belt/breaker reinforcement (25) disposed over said carcass ply (18) in a crown area of said tire, and tread (12) disposed over said belt/breaker reinforcement (25), said tire characterized by a turn up (22) of carcass ply (18) extending the full height of sidewall (14) and having an end (24) disposed radially inward of belt edge (26) in a crown area of said tire, and said turn up (22) being wrapped substantially around bead (28) and being substantially contiguous with carcass ply (18) substantially from bead (28) to end (24).

2. The tire of claim 1 wherein chapex (34) substantially fills the area radially outward of bead (28) and covers the axially outward surface of turn-up (22) substantially from bead (28) to substantially 60% to 95% of the distance from bead (28) to the section width (SW) of said tire.

3. The tire of claim 1 wherein the aspect ratio is 60 to 80.

4. The tire of claim 1 wherein chapex (34) overlaps with sidewall (14) about 40% to 75% of the distance from toe (34b) of chapex (34) to tip (34a) of chapex (34).
